(19) United States
(12) Patent Application Publication
(10) Pub. No.: US 2026/0093558 A1
(43) Pub. Date: Apr. 2, 2026

(54) SYSTEM AND METHOD FOR FULFILLING SERVICE REQUEST USING COMPUTING NODES

(71) Applicant: ASSMBL.AI LIMITED, Bury St Edmunds (GB)

(72) Inventor: Humayun Munir Sheikh, Bury St Edmunds (GB)

(21) Appl. No.: 18/903,066

(22) Filed: Oct. 1, 2024

(51) Int. Cl. G06F 9/52

(52) U.S. Cl. CPC G06F 9/52

(57) ABSTRACT

Disclosed is system for fulfilling service request using computing nodes. The system comprises a decentralized computing network, comprising computing nodes operating as autonomous agents, configured to implement software framework comprising: client-agent device configured to: receive service request and generate objective therefor, and send objective to agent-device configured to send queries to a machine learning model agent and/or obtain tasks, and list of autonomous agents associated with objective; and processing arrangement configured to: generate directed acyclic graph (DAG) having nodes representing first task and edges representing dependency of first task on second task(s) amongst tasks, and initialize Bloom filter of each node to track completion status of second task(s). Autonomous agent is configured to: identify second task(s), check completion status of second task(s), using Bloom filter of first task, upon completion of second task(s), execute first task, and update Bloom filter.

### TECHNICAL FIELD

The present disclosure relates to systems for fulfilling service requests using computing nodes. Moreover, the present disclosure relates to methods for fulfilling service requests using computing nodes.

### BACKGROUND

Autonomous agents (AAs) have gained significant attention in recent years as a promising technology for addressing complex tasks across various problem domains. The autonomous agents (AAs) possess the ability to perceive their environment, make decisions, and take actions autonomously, thereby reducing the need for direct human intervention. However, existing systems that employ autonomous agents face several limitations and challenges that hinder their widespread adoption and effectiveness.

In existing solutions, each autonomous agent operates independently, capable of making decisions, planning, and executing tasks without constant oversight, which enables each autonomous agent to specialize in specific roles, allowing for more efficient and effective task execution. However, the independent nature of each autonomous agent leads to challenges in maintaining an alignment with an overall objective of a service request. The autonomy in the existing solutions that enables efficient task execution also poses a risk of the autonomous agents focusing too narrowly on their assigned roles, potentially neglecting the overall objective of the service request.

Therefore, in light of the foregoing discussion, there is a need to overcome the aforementioned drawbacks.

### SUMMARY

The aim of the present disclosure is to provide a system and a method to ensure sub-tasks are executed in alignment with an objective associated with a service request. The aim of the present disclosure is achieved by a system and a method for fulfilling a service request using computing nodes as defined in the appended independent claims to which reference is made to. Advantageous features are set out in the appended dependent claims.

Throughout the description and claims of this specification, the words “comprise”, “include”, “have”, and “contain” and variations of these words, for example “comprising” and “comprises”, mean “including but not limited to”, and do not exclude other components, items, integers or steps not explicitly disclosed also to be present. Moreover, the singular encompasses the plural unless the context otherwise requires. In particular, where the indefinite article is used, the specification is to be understood as contemplating plurality as well as singularity, unless the context requires otherwise.

### BRIEF DESCRIPTION OF THE DRAWINGS

FIG. 1A is an illustration of a block diagram of a system for fulfilling a service request using computing nodes, while FIG. 1B is an illustration of a block diagram of a software framework implemented by a decentralized computing network of the system, in accordance with an embodiment of the present disclosure; and

FIG. 2 (i.e. FIGS. 2A and 2B) is an illustration of a flowchart depicting steps of a method fulfilling a service request using computing nodes, in accordance with an embodiment of the present disclosure.

### DETAILED DESCRIPTION OF EMBODIMENTS

The following detailed description illustrates embodiments of the present disclosure and ways in which they can be implemented. Although some modes of carrying out the present disclosure have been disclosed, those skilled in the art would recognize that other embodiments for carrying out or practicing the present disclosure are also possible.

In a first aspect, the present disclosure provides a system for fulfilling a service request using computing nodes, the system comprising a decentralized computing network configured to implement a software framework, wherein the decentralized computing network comprises a plurality of computing nodes configured to operate as autonomous agents (AAs), which are configured to execute a plurality of modular and extensible software modules, wherein the autonomous agents are communicably coupled with each other, wherein the software framework comprises:
a client-agent device (client-AA) comprising a software application configured to:
   receive the service request and generate an objective associated with the service request, wherein the objective is in a form of one or more vectors recorded in a vector database, and
   send the objective to an agent-device (AA), wherein the agent-device comprises a context-builder software module configured to upon receiving the objective, send one or more queries to a machine learning model agent (ML-Model AA) and/or to access the vector database to obtain a plurality of tasks associated with the objective, and obtain a list of a plurality of autonomous agents that are associated with the objective;
a processing arrangement configured to:
   generate a directed acyclic graph (DAG), wherein each node in the DAG represents a first task amongst the plurality of tasks and each edge in the DAG represents a dependency of the first task on a second task amongst the plurality of tasks, and
   initialize a Bloom filter associated with each node of the DAG to track a completion status of each of at least one second task on which the first task is dependent;
wherein each autonomous agent amongst the plurality of autonomous agents is configured to:
   identify the at least one second task on which the first task associated to said autonomous agent is dependent, based on the DAG,
   check (i.e. verify) the completion status of each of the identified at least one second task, using the Bloom filter associated with the first task,
   upon successful completion of each of the identified at least one second task, execute the first task, and
   update the Bloom filter associated with the first task.

The present disclosure provides an aforementioned system that enables to maintain an alignment of intermediate outputs from execution of the plurality of tasks with the objective associated with the service request. Moreover, the aforementioned system effectively ensures that each of the plurality of tasks are executed in a required workflow for achieving the objective associated with the service request. Furthermore, the use of the Bloom filter provides a fast and a storage-efficient way to check the completion status of each of the at least one second task before the first task is executed.

In a second aspect, the present disclosure provides a method for fulfilling a service request using computing nodes, the method comprising:
implementing a software framework, via a decentralized computing network, wherein the decentralized computing network comprises a plurality of computing nodes configured to operate as autonomous agents (AAs), which are configured to execute a plurality of modular and extensible software modules, wherein the autonomous agents are communicably coupled with each other;
receiving, at a client-agent device (client-AA) comprising a software application, the service request and generating an objective associated with the service request, wherein the objective is in a form of one or more vectors recorded in a vector database;
sending the objective from the client-AA to an agent-device (AA), wherein the agent-device comprises a context-builder software module configured to upon receiving the objective, send one or more queries to a machine learning model agent (ML-Model AA) and/or to access the vector database to obtain a plurality of tasks associated with the objective, and obtain a list of a plurality of autonomous agents that are associated with the objective;
generating a directed acyclic graph (DAG), wherein each node in the DAG represents a first task amongst the plurality of tasks and each edge in the DAG represents a dependency of the first task on second task amongst the plurality of tasks, using a processing arrangement;
initializing a Bloom filter associated with each node of the DAG to track a completion status of each of at least one second task on which the first task is dependent, using the processing arrangement;
identifying the at least one second task on which the first task associated to said autonomous agent is dependent, based on the DAG;
checking the completion status of each of the identified at least one second task, using the Bloom filter associated with the first task;
upon successful completion of each of the identified at least one second task, executing the first task; and
updating the Bloom filter associated with the first task.

The present disclosure provides an aforementioned method that enables to maintain an alignment of intermediate outputs from execution of the plurality of tasks with the objective associated with the service request. Moreover, the aforementioned method effectively ensures that each of the plurality of tasks are executed in a required workflow for achieving the objective associated with the service request. Furthermore, the use of the Bloom filter provides a fast and a storage-efficient way to check the completion status of each of the at least one second task before the first task is executed.

Throughout the present disclosure, the term “autonomous agents” refers to computational entities or software programs that are designed to perform tasks or make decisions autonomously, without direct human intervention. The autonomous agents could perceive their environment, analyze information, and take actions based on predefined rules, algorithms, or learning capabilities. Optionally, the autonomous agent is an autonomous economic agent. In this regard, an autonomous micro-agent is optionally a micro autonomous economic agent. Optionally, the autonomous economic agent relates to a software module, or any device comprising at least one software module that is configured to execute one or more tasks. Such tasks may include communication of the autonomous economic agents with each other, processing of information, and so forth. In an example, the autonomous economic agents are configured to employ artificial intelligence (AI) algorithms and machine learning for the execution of the one or more tasks.

The system comprises the decentralized computing network that is configured to implement the software framework. Herein, the software framework encompasses any software abstraction which can have one or more software modules to provide generic and/or specific functionality (or specific functionalities). Optionally, the software framework is an agent framework. An agent framework may be a framework that enables the creation of application-specific autonomous agents, an open economic framework employing autonomous agents, or a framework designed for developers (person or by artificial intelligence) to develop applications where both agents and a large language model are included in the application. For example, this may be a framework that is designed to simplify creation of applications using Large Language Models (LLMs). In this regard, the software framework is a specific implementation of the decentralized computing network, designed for the purpose of developing the autonomous agents and for enabling the autonomous agents to interact and transact with each other. The software framework provides the infrastructure and resources for the autonomous agents to communicate, negotiate, and exchange value in a secure and transparent manner. Herein, the open economic framework refers to a computing framework that encompasses a discovery and incorporation of new micro-agents by using the Large Language Model (LLM) and enable the execution of tasks associated with the autonomous agents within the software framework. Notably, the software framework may provide a standard interface for the autonomous agents, and a selection of the autonomous agents to choose from.

Notably, the decentralized computing network comprises the plurality of computing nodes that are communicably coupled to each other, and wherein each of the plurality of computing nodes comprises at least one processor, at least one memory device, and a communication interface. In this regard, when in operation, each of the plurality of computing nodes can perform as either a client device or a service component. Optionally, each of the plurality of computing nodes comprises at least one processor, at least one memory device, and a communication interface. Optionally the computing node is one of: a Large Language Model (LLM), a machine learning (ML) agent, the client-agent device. Furthermore, the decentralized computing network is optionally implemented as a decentralized structured P2P (peer-to-peer) network of devices; alternatively, multi-layer communication networks are employed, wherein communication devices are migrated between the layers depending upon their technical functionality, reliability, peer review assessment and/or trustworthiness. Specifically, the decentralized structured P2P network represents a decentralized computing environment within a P2P network.

Moreover, the decentralized computing network includes wired and/or wireless communication arrangements (namely “communicating means”) comprising a software component, a hardware component, a network adapter component, or a combination thereof. Furthermore, the communication network may be an individual network, or a collection of individual networks, interconnected with each other and functioning as a single large network. Such individual networks may be wired, wireless, or a combination thereof. In an example, the communication network includes Bluetooth®, Internet of things (IoT), Visible Light Communication (VLC), Near Field Communication (NFC), Local Area Networks (LANs), Wide Area Networks (WANs), Metropolitan Area Networks (MANs), Wireless LANs (WLANs), Wireless WANs (WWANs), Wireless MANs (WMANs), the Internet, telecommunication networks, radio networks, and so forth.

Optionally, the software framework includes the plurality of autonomous agents which are communicably interconnected using the decentralized computing network. Optionally, the plurality of autonomous agents serves as a plurality of worker nodes of the decentralized computing network, for collectively fulfilling a plurality of autonomous agents-based functionalities belonging to the plurality of problem domains. The term “autonomous agents-based functionalities” as used herein refers to one or more functionalities of the autonomous agents, that enable the autonomous agents to serve the service request. Such functionalities may be, enabling digital payments, generating product recommendations, resolving customer queries, and the like. In this regard, the autonomous agents use the open economic framework for collectively fulfilling the service requests belonging to the plurality of problem domains. Optionally, the worker nodes include computing arrangements that are operable to respond to, and processes instructions and data therein.

The computing arrangements may include, but are not limited to, a microprocessor, a microcontroller, a complex instruction set computing (CISC) microprocessor, a reduced instruction set (RISC) microprocessor, a very long instruction word (VLIW) microprocessor, an artificial intelligence (AI) computing engine based on hierarchical networks of variable-state machines, or any other type of processing circuit. Furthermore, the computing arrangements can be one or more individual processors, processing devices and various elements associated with a processing device that may be shared by other processing devices. Additionally, the computing arrangements are arranged in various architectures for responding to and processing the instructions that drive the system. The computing arrangements are processing devices that operate automatically. In such regard, the computing arrangements may be equipped with artificial intelligence algorithms that are configured to respond to and to perform the instructions that drive the system based on data learning techniques. The computing arrangements devices are capable of automatically responding and of performing instructions based on input provided by the one or more users (namely, the worker nodes participating in the system). The worker nodes further include local databases to store data therein. Furthermore, the collective learning of the worker nodes is managed within the system. Notably, the computing model is trained between the plurality of worker nodes in a manner that the intermediary computing models that have been partially trained are shared between the worker nodes and resources of worker nodes are utilized productively.

Moreover, the plurality of worker nodes is communicably coupled to each other via the decentralized computing network. For example, the software framework is configured to allow access to the autonomous agents to operate within the software framework based on a set of rules and/or security protocols. Similarly, the software framework may deny access to the autonomous agents to operate within the software framework upon determining that the autonomous agents do not comply with the set of rules and/or security protocols. In one example, the software framework is implemented by the autonomous agents that are configured to enable communication between other autonomous agents within the software framework, process information associated with an interaction between other autonomous agents within the software framework, provide (or deny) access to the autonomous agents to the software framework and so forth. Moreover, the software framework enables to provide a decentralized economic market for enabling various services to be provided and/or procured by autonomous agents. Such a decentralized economic market may be representative of a real-world environment, such as a real-world market where one or more services are provided and/or procured by the autonomous agents.

Moreover, optionally, a distributed ledger arrangement is consensually shared and synchronized in a decentralized form across the plurality of worker nodes. The distributed ledger arrangement refers to a database of entries or blocks of data.

In an example embodiment, the service requests provided by the autonomous agents is a collective bid provided by multiple autonomous agents, wherein the multiple autonomous agents collectively provide the service to the plurality of computing nodes. It will be appreciated that a given autonomous agent may only be capable to execute a portion of the service request that is generated by the plurality of computing devices. The service request may include a plurality of steps. The term “collective bid” as used herein refers to a bid that is generated and communicated by the given autonomous agent to the plurality of computing nodes, wherein the given autonomous agent acts on behalf of multiple autonomous agents, and wherein the multiple autonomous agents collectively provide the service to the plurality of computing nodes. In such an instance, the given autonomous agent may simultaneously be a client autonomous agent, namely a secondary client autonomous agent, that may be acquiring services from one or more other autonomous agents, namely a second plurality of autonomous agents for the execution of the remaining portion of the service.

Optionally, at least one service bid (offer made by a service provider) of the plurality of service bids is a collaborative service bid associated with two or more autonomous agents. In an example, the service bid for the aforesaid service request for transporting the user from Birmingham to Amsterdam may include at least two service providers such as travel agents. In such example, one service provider may be from Birmingham and the other service provider may be from Amsterdam. In such example, the service provider from Birmingham may provide service based on the rules and norms of the United Kingdom and the service provider from Amsterdam may provide service based on the rules and norms of the Netherlands. Therefore, the service bid generated by the service providers may include the rules and norms of United Kingdom and Netherlands. In such instance the autonomous agents associated with the service components of the service provider from Birmingham may communicate with the autonomous agents of the service components of the service provider from Amsterdam. Furthermore, the autonomous agents are operable to determine the travel route of the user that is safe, fast, and cost-effective. Optionally, the service provider may collaborate with another service provider including the service component to complete the service request such as the request for surveying the area using a drone having specific sensors generated by the user.

The plurality of computing nodes are configured to operate as the autonomous agents (AAs), which are configured to execute the plurality of modular and extensible software modules meaning that the autonomous agents are modular and extensible, thus the autonomous agents are self-sufficient entities executed by the plurality of computing nodes that could function independently and could be reused and adapted or modified as needed to fit various use cases/circumstances based on their own rules and objectives. The autonomous agents are modular, meaning that they are composed of separate parts or units that can be combined together in various manners to achieve a variety of functionalities. The autonomous agents are extensible, meaning that their existing functionalities are capable of being extended further by addition of newer modular parts or units. It will be appreciated that when multiple autonomous agents work collectively for an application (i.e. use case), different steps of the application are completed by different autonomous agents. The multiple autonomous agents work in consensus to collectively reach a final outcome for achieving a required functionality of said application. Additionally, the autonomous agents could be modulated to perform new tasks, respond to changing market conditions, or interact with new environment without disrupting the overall functioning thereof or the system it operates within. The reusability and compositions of the autonomous agents reduce the use of computation resources required to fulfil the service request. Moreover, the reusability makes the development and expansion of the system's functionality time-efficient since it reduces or removes the need for re-programming the autonomous agents. Furthermore, the composition and reusability of autonomous agents or composed autonomous agents provides a way to handle any complex action by using existing protocols without the need to start from scratch thus reducing the use of computational resources. Also, the ability to expand and adapt makes autonomous agents more versatile and sustainable, thereby making the autonomous agents future proof. Herein, the plurality of problem domains may include, but is not limited to, energy, finance, supply chain, governance, manufacturing, mobility, smart cities, and internet of things (IoT) applications.

Optionally, the autonomous agents are combined with human-readable text input to create a scalable AI infrastructure that supports Large Language Models (LLMs), which is referred to as an AI engine. It is an essential component of an AI-based chat interface and its functionalities. The goal of the AI engine is to analyze, understand and link human input to the autonomous agents by facilitating natural language interactions. The AI engine reads the user input, converts it into actionable tasks and selects the most appropriate autonomous agent to perform the task. Optionally, the AI-based chat interface serves as a front-end gateway to the AI Engine. It offers users a straightforward chat interface through which they can input the service requests. The service requests are then translated by the AI Engine into a series of tasks to be executed.

It will be appreciated that by providing the client-agent device as part of the software framework, the system enables users to interact with the plurality of autonomous agents and utilize the capabilities of the software framework to accomplish various tasks and objectives. Throughout the present disclosure, the term “software application” refers to a modular and extensible software module that functions as an application programming interface (API). Typically, the application programming interface (API) is a set of rules and protocols that allows different software applications to communicate and interact with each other. Optionally, the software application within the client-agent device could be a chatbot that interacts with users through natural language processing. Optionally, the software application could be a task management application that allows users to create, assign, and track tasks. Optionally, the software application could function as a virtual assistant application that assists users with various tasks and provides personalized recommendations or services. Optionally, the software application could serve as an intelligent shopping assistant, and so forth.

Throughout the present disclosure, the term “service request” as used herein refers to a specific action or communication made by a user, typically through a digitalized system, to seek a particular service or assistance. Optionally, the service request can take various forms, such as direct interactions with digital interfaces like voice assistants (such as Siri, Alexa, ChatGPT, and so forth), inputting information into dedicated applications, or entering appointments into personal calendars. Optionally, the service request may include metadata, which is additional information accompanying the request, and is utilized by the Large Language Model (LLM) to provide relevant inferences or responses. Optionally, the service request may originate from individuals or authorized entities, including the digital twins or company Large Language Models (LLMs) empowered to request services on behalf of the clients, such as arranging travel services.

In an embodiment, the service request includes at least one of: a time needed for providing the service, a price associated with the service, a quality associated with the service, and/or at least one preference associated with the service. For example, the user specifies a parameter (such as, using the graphical user interface associated with client-agent device) including at least one of: time, price, quality and/or at least one preference that is required by the user in the provided service. In such an instance, the parameter is provided to the client-agent device with the generated service request. In one example, the service request includes the price associated with the service, such as a minimum and maximum price associated with the service.

Optionally, the service request is received from at least one of: a software application executing on a device of a user, a software application executing on a computing device that is communicably coupled to a device of a user, a cloud-based software application, a digital twin of a user, a digital representation of a user, an artificial intelligence model (AI-model) based on a Large Language Model (LLM). In this regard, the service request can be received from the software application such as a mobile application or a desktop application installed or executed on the user's device. For example, a user using a travel planning application on their smartphone can make a service request to book a hotel. Optionally, the service request can be received from a software application executing on the computing device such as a home automation hub that is communicably coupled to the user's device (such as a smartphone) through a wireless connection. In such a case, the user utilizes the software application on their smartphone to interact with and send service requests to the home automation hub, enabling the user to control and manage various aspects of a smart home environment. Optionally, the service request is received from the cloud-based software application such as Google Calendar.

Optionally, the service request can be received from the digital twin that refers to a virtual representation of a given user. It will be appreciated that a given digital twin is updated in real-life, from real-time data. Optionally, the given digital twin employs simulation, machine learning and reasoning to assist in decision-making. Typically, the given digital twin spans a lifetime of the given user, however, a lifetime of the given digital twin may vary based on requirements of the given user. Optionally, the given digital twin being the autonomous agent means that the given digital twin is capable of autonomously making decisions on behalf of the given user. Optionally, the digital twin could be a party sending the service request.

Optionally, the service request can be received from the digital representation of the user that refers to a computer-generated representation of the user. For example, the digital representation could be a chatbot or an avatar that interacts with the system on the user's behalf. For instance, a user's digital representation engaging in a virtual meeting and making a request for a presentation to be shared. Optionally, the service request can be received from the artificial intelligence model (AI-model) based on the Large Language Model (LLM) to generate natural language responses or carry out tasks. For example, a user interacting with a language-based AI assistant like ChatGPT to request information about nearby restaurants. Beneficially, the system can receive the service requests from diverse sources, including various software applications, cloud-based services, digital twins, digital representations, and AI models. This broadens the accessibility and flexibility of the system, allowing users to interact with the system through different channels or interfaces. Optionally, in task refinement the machine learning model agent such as the Large Language Model may be used to break down any task into its sub-tasks or may provide alternatives or variants of doing said task. The user may also provide the input for selection of a given alternative or variant amongst the alternatives or variants provided.

Throughout the present disclosure, the term “objective” refers to a desired outcome or goal that the client-agent device aims to achieve based on the service request received therethrough. Optionally, the objective defines the purpose or intent behind the service request. In this regard, the objective is generated by the software application executed on the client-agent device. The objective is typically formulated in a structured manner to provide clarity and guidance for the subsequent actions of the client-agent device and the autonomous agents in the system. For example, the objective could be to book a flight to Paris, when the service request is to find and book a flight to Paris. In another example, the objective could be to schedule a meeting with an individual on a specific day. In yet another example, the objective could be to order groceries and deliver them by a specified date.

Optionally, when generating the objective associated with the service request, the software application executed on the client-agent device is configured to:
send the service request to a Large Language Model (LLM) for processing, wherein the Large Language Model (LLM) is configured to transform the service request into a service data associated with the service request, the service data being in a form of one or more vectors recorded in a vector database,
receive the service data from the Large Language Model (LLM), and
use the service data received from the Large Language Model (LLM) as the objective.

In this regard, the software application utilizes the Large Language Model (LLM) to process the service request. Notably, the Large Language Model is an artificial intelligence model trained on a vast amount of textual data, enabling it to understand and generate humanlike language responses. Moreover, when the software application refers the service request to the Large Language Model, it uses natural language processing techniques to analyze and interpret the service request. The Large Language Model understands the context, identifies key information, and extracts relevant details from the service request. Moreover, once the Large Language Model processes the service request, it transforms the extracted information into service data represented as the one or more vectors. The one or more vectors capture the essential characteristics or attributes of the service request in a structured format. For example, if the service request is to find a nearby restaurant, the Large Language Model can extract information such as the desired cuisine, location, price range, and any specific dietary restrictions. This information is then converted into a vector representation with each dimension representing a specific attribute (such as cuisine, location, price, and so forth).

Furthermore, the service data, in the form of one or more vectors, generated by the Large Language Model is used as the objective associated with the service request. It becomes the refined and structured representation of the user's request, suitable for further processing within the system. For instance, the transformed service data vector may be used by other autonomous agents in the system to match the user's preferences with available restaurants, recommend suitable options, or make decisions based on the extracted attributes. The technical effect of sending the service request to the Large Language Model (LLM) is that it allows for efficient storage, retrieval, and manipulation of the objective within the system, enhancing the system's ability to understand and fulfil the user requests accurately and effectively. Further, the service request received from the user is in an unstructured data format which is converted to a structured and meaningful data using the language model module.

The client-agent device (client-AA) then passes the objective to the agent-device, which can be a specialized micro-AA or a more comprehensive AA, responsible for executing specific tasks or managing specific domains within the system. This allows for efficient division of labor and facilitates the seamless processing and execution of the service requests. The term “context-builder software module” as used herein refers to a component of the agent-device (AA or micro-AA) within the system. It is responsible for building the context necessary to execute tasks associated with the objective received from the client-agent device (client-AA). In this regard, upon receiving the objective, the context-builder software module sends one or more queries to the machine learning model agent (ML-Model AA). The machine learning model agent (ML-Model AA) could be an autonomous agent that specializes in machine learning tasks and has the ability to provide insights and information based on previous queries or experiences. Optionally, the context-builder software module is communicably coupled with a platform which enables creation, testing, development, deployment and management of autonomous agents. Optionally, the platform is also communicably coupled to the vector database. Optionally, the platform could be an agentverse which is a tool that serves as a portal to the broader agent-based software frameworks and toolsets. Optionally, the platform provides a library of pre-built agents, an analytics dashboard, and an intuitive interface, making it a powerful platform for creating intelligent software autonomous agents (AAs).

Optionally, the machine learning model agent (ML-Model AA) is at least one of: an internal Large Language Model (Internal-LLM) of the agent-device (AA or micro-AA), an external Large Language Model (External-LLM) associated with the agent-device (AA or micro-AA). In this regard, the machine learning model agent (ML-Model AA) is capable of performing tasks related to language understanding and processing by transforming the service request or the objective into service data in the form of the one or more vectors recorded in the vector database. It will be appreciated that the system allows for flexibility in the selection of the machine learning model agent (ML-Model AA) by providing options for both the internal Large Language Model (Internal-LLM) and the external Large Language Model (External-LLM). Moreover, depending on the specific implementation or configuration, the machine learning model agent (ML-Model AA) can be either the internal Large Language Model (Internal-LLM) residing within the agent-device (AA or micro-AA), or the external Large Language Model (External-LLM) associated with the agent-device.

For example, the service request to find information about a specific topic is received by the client-agent device (client-AA). The ML-Model AA, acting as a language model, receives the objective and processes the objective using its natural language processing capabilities. If the internal Large Language Model (Internal-LLM) is employed, it performs the necessary computations and transforms the request into the service data internally within the agent-device. On the other hand, if the external Large Language Model (External-LLM) is used, the objective is sent to the associated external model, which processes the request and provides the required service data back to the agent-device.

The context-builder software module is configured to access the vector database, which contains one or more vectors recorded in it. The context-builder software module retrieves tasks associated with the previous queries from the vector database to obtain the plurality of tasks associated with the objective. For example, for fulfilling the service request P, the plurality of tasks comprising tasks S₁, S₂, S₃. . . , Sₙ are obtained that are to be executed. Optionally, by accessing the vector database, the context-builder software module gathers relevant information and tasks that are similar or related to the current objective. Optionally, by retrieving previous tasks associated with similar queries or objectives, the context-builder software module enhances the understanding of the current objective and enables the system to provide more accurate and relevant responses or actions.

Optionally, the context-builder software module also interacts with the machine learning model agent (ML-Model AA) to obtain the list that includes multiple autonomous agents (AAs or micro-AAs) associated with the objective and can contribute to its execution. For example, the machine learning model agent (ML-Model AA) provides the list of the plurality of autonomous agents associated with the objective, which helps in assembling a team of agents capable of handling different tasks related to the vacation planning process.

Optionally, the list of the plurality of autonomous agents that are associated with the objective, is generated using a registry component and a search and discovery component, wherein the registry component comprises a database of the autonomous agents and their components, and wherein the search and discovery component is configured to find, using the database, the at least one autonomous agent which is capable of performing the at least one task.

Optionally, the context-builder software module engages in a dynamic exchange of information with the machine learning model agent (ML-Model AA) to determine an order in which each task amongst the plurality of tasks needs to be executed for effectively fulfilling the service request. For example, when the objective is to plan a vacation, and there are multiple tasks involved, such as booking flights, reserving accommodation, and arranging transportation. In such a case, the context-builder software module communicates with the machine learning model agent (ML-Model AA) to obtain insights and recommendations on the optimal order in which these tasks should be executed. Moreover, the machine learning model agent (ML-Model AA) might provide recommendations based on factors like availability, cost, or user preferences.

Throughout the present disclosure, the term “processing arrangement” refers to a computational element that is operable to execute instructions of the system. Examples of the processing arrangement include, but are not limited to, a microprocessor, a microcontroller, a complex instruction set computing (CISC) microprocessor, a reduced instruction set (RISC) microprocessor, a very long instruction word (VLIW) microprocessor, or any other type of processing circuit. Furthermore, the processing arrangement may refer to one or more individual processors, processing devices and various elements associated with a processing device that may be shared by other processing devices. Additionally, one or more individual processors, processing devices and elements are arranged in various architectures for responding to and processing the instructions that execute the instructions of the system.

Throughout the present disclosure, the term “directed acyclic graph (DAG)” refers to a graph that is directed in a specific direction (i.e. from one node to another node in the DAG), without forming any cycles therein. Notably, the specific direction in which the DAG is directed is based on the order in which each task amongst the plurality of tasks needs to be executed. The generation of the DAG enables to represent the plurality of tasks and dependencies between the plurality of tasks in a sparse and memory-efficient manner. Throughout the present disclosure, the term “node” refers to a vertex in the DAG that represents an entity or an object. Throughout the present disclosure, the term “first task” refers to a particular task from amongst the plurality of tasks. Notably, each node of the DAG being used to represent the first task amongst the plurality of tasks enables to represent each of the plurality of tasks as nodes of the DAG. Similarly, each edge of the DAG being used to represent the dependency of the first task on the second task amongst the plurality of tasks enables to effectively represent the dependency of each of the first task on each of the at least one second task as edges of the DAG.

Throughout the present disclosure, the term “at least one second task” refers to those one or more tasks amongst the plurality of tasks that needs to be completed before executing the first task based on the order in which each task amongst the plurality of tasks needs to be executed. Optionally, the at least one second task comprises the second task, a third task, a fourth task, and the like. Subsequently, the first task represented by each node is dependent on the at least one second task as represented by the edges of the DAG. Optionally, the dependency of the first task amongst the plurality of tasks on the at least one second task amongst the plurality of tasks is determined based on a pre-requisite workflow to be followed to execute the objective. In this regard, the term “pre-requisite workflow” refers to the order in which each task amongst the plurality of tasks needs to be executed for effectively fulfilling the service request. A technical effect of the dependency of the first task on the at least one second task being determined based on the pre-requisite workflow enables to ensure that an intermediate output obtained from executing the first task is aligned with the objective associated with the service request.

Throughout the present disclosure, the term “completion status” refers to an indicator that indicates whether a certain task is completed on not. The completion status of the certain task being positive indicates that the certain task is completed, and the completion status of the certain task being negative indicates that the certain task is incomplete. Throughout the present disclosure, the term “Bloom filter” refers to a space efficient probabilistic data structure that is used to check the presence of element within a set. Notably, the Bloom filter associated with each node contains the probabilistic data of the completion status of each of the at least one second task as a combined set which can be used to check the completion status of any of the at least one second task. Therefore, having the Bloom filter associated with each node allows the system to verify the completion status of each task without the need of further data transfer between computing nodes about the task, except of the change in status of the bloom filter. Notably, insertions and queries in the Bloom filter have a time complexity function of O(k), where k is the number of the hash functions, which ensures that operations in the Bloom filter are performed in a constant time, regardless of the number of tasks. Therefore, since the Bloom filter may be updated and tracked in a constant time period, regardless of the number of tasks, response time that is close to instantaneously even in large-scale applications(i.e. applications in which the number of tasks is relatively large) The system does not experience any delays associated with data transfers and/or data processing that would otherwise be required.

Optionally, the Bloom filter comprises a bit array of a predefined size. In this regard, the term “bit array” refers to a data structure that is used to compactly store an array of bits, and allows effective manipulation thereof. Notably, each bit in the bit array is used to store the completion status of a corresponding second task amongst the at least one second task. Moreover, the predefined size of the bit array is equal to the number of the at least one second task on which the first task associated with the Bloom filter is dependent. A technical effect of the Bloom filter comprising the bit array of the predefined size is that the completion status of each of the at least one second task is stored in form of bits which reduces storage requirements and allows for compact storage.

Optionally, the completion status in the Bloom filter is represented using the bit array and hash functions. In this regard, the term “hash functions” refers to mathematical functions that take data associated with the at least one second task as input and returns a fixed-size string of bytes as the completion status of the at least one second task to be stored in the bit array. Notably, the use of the hash functions removes the need for storing detailed records of each of the at least one second task. It is therefore clear that the effect of the use of has function in the present context results in a significantly lower memory consumption in the computer system when storing the completion status in the Bloom filter.

Optionally, a number of the hash functions and the predefined size of the bit array in the Bloom filter are used to minimise false positives in the Bloom filter. In this regard, the term “false positives” refers to those instances when the completion status of said task in the Bloom filter is indicated to be completed even when said task is not executed in actual. Notably, the probabilistic nature of the Bloom filter allows to have a controlled error rate of the false positives in the Bloom filter, which can be tuned based on the number of the hash functions and the predefined size of the bit array in the Bloom filter. A technical effect of the false positives being minimized is that a high accuracy in tracking the completion status of the at least one second task in the Bloom filter is maintained.

It will be appreciated that the at least one second task being identified by said autonomous agent enables said autonomous agent to know those one or more tasks amongst the plurality of tasks that needs to be executed before the execution of the first task associated to said autonomous agent. Subsequently, the at least one second task is identified using the DAG by identifying the at least node that is connected to the node representing the first task, via the at least one edge in the DAG.

Notably, the Bloom filter associated with the first task used to check if each of the identified at least one second task is completed or not, as the completion status of each of the identified at least one second task is stored in the Bloom filter associated with the first task. Moreover, the use of the Bloom filter removes the need for redundant and repetitive checks against a full list of databases of the at least one second task. Furthermore, the use of the Bloom filter minimizes the need for frequent input/output operations for tracking the completion status of the at least one second task, thus, increasing efficiency and reducing latency.

The successful completion of each of the identified at least one second task is determined when the completion status of each of the identified at least one second task is positive in the Bloom filter. Subsequently, upon the successful completion of each of the identified at least one second task, the first task is executed by said autonomous agent as the execution of the first task now follows the order in which each task amongst the plurality of tasks is to be executed.

Optionally, the software framework comprises a protocol generator software module comprising a domain independent protocol specification language, wherein the protocol generator software module is configured to generate at least one protocol specification for the execution of the plurality of tasks associated with the objective, wherein the at least one protocol specification is generated using the domain-independent protocol specification language. Optionally, each autonomous agent is further configured to implement the at least one protocol specification to execute the first task. In this regard, the term “protocol generator software module” as used herein refers to a software tool that generates the at least one protocol specification for the at least one autonomous agent using the domain-independent protocol specification language. The term “protocol specification” as used herein refers to an implementation of the rules and guidelines that are to be followed for the execution of the one or more tasks associated with the objective for which the protocol specification is generated. Moreover, the at least one protocol specification defines how messages are encoded for a transportation thereof. Optionally, the at least one protocol specification includes constraints or conditions to ensure that a certain message sequence follows a specific pattern. For example, a “SELL” message must follow a “BUY” message, and a “FINISH” message must follow a “START” message. Additionally, such constraints help to maintain the consistency and integrity of the stateful communication of the at least one autonomous agent. Throughout the present disclosure, the term “domain-independent specific language” refers to a formal language that enables the definition of protocols for interactions across the plurality of problem domains. In this regard, the domain-independent protocol specification language is used to describe the format, structure, and rules for communication among the computing nodes. It will be appreciated that the domain-independent protocol specification language provides a standardized way of defining protocols that enables interoperability and seamless communication among the autonomous agents in the distributed computer system, regardless of the domain thereof. Moreover, the domain-independent protocol specification language in the software framework promotes fairness, transparency, and efficiency in the distributed computer system. Furthermore, the domain-independent protocol specification language enables the distributed computer system to become scalable for providing multidomain services. Optionally each of the at least one protocol specification is identified using manifest (namely, a unique identifier).

Optionally, the domain-independent protocol specification language is stored in a form of a set of instructions, in at least one memory device of the decentralized computing network. Optionally, the at least one memory device may be a physical memory device, such as a hard drive or a flash drive, or a virtual memory device, such as a cloud-based server.

Subsequently, after the execution of the first task, the Bloom filter is updated by updating the completion status of the first task as positive in the Bloom filter. The Bloom filter associated with the first task being updated enables other tasks that are dependent on the first task to track the first task as completed.

The present disclosure also relates to the method as described above. Various embodiments and variants disclosed above, with respect to the aforementioned system, apply mutatis mutandis to the method.

Optionally, the dependency of the first task amongst the plurality of tasks on the at least one task amongst the plurality of tasks is determined based on a pre-requisite workflow to be followed to execute the objective.

Optionally, the Bloom filter comprises a bit array of a predefined size.

Optionally, the completion status in the Bloom filter is represented using the bit array and hash functions.

Optionally, a number of the hash functions and the predefined size of the bit array in the Bloom filter are used to minimize false positives in the Bloom filter.

### DETAILED DESCRIPTION OF THE DRAWINGS

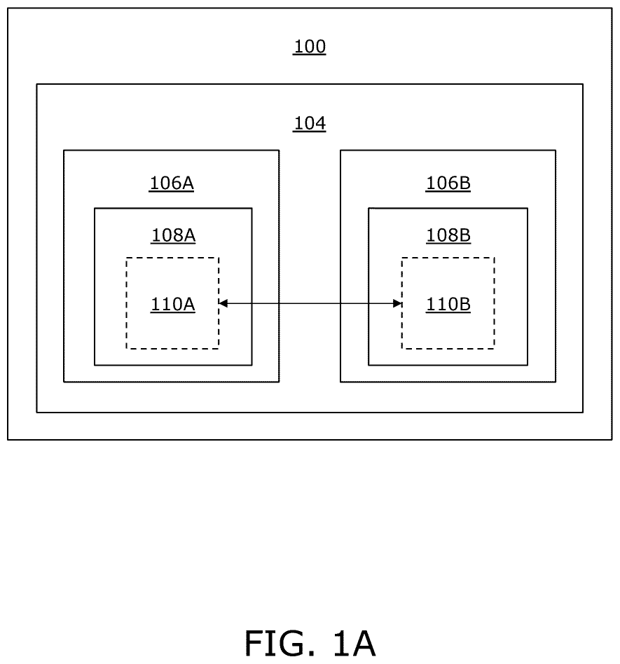

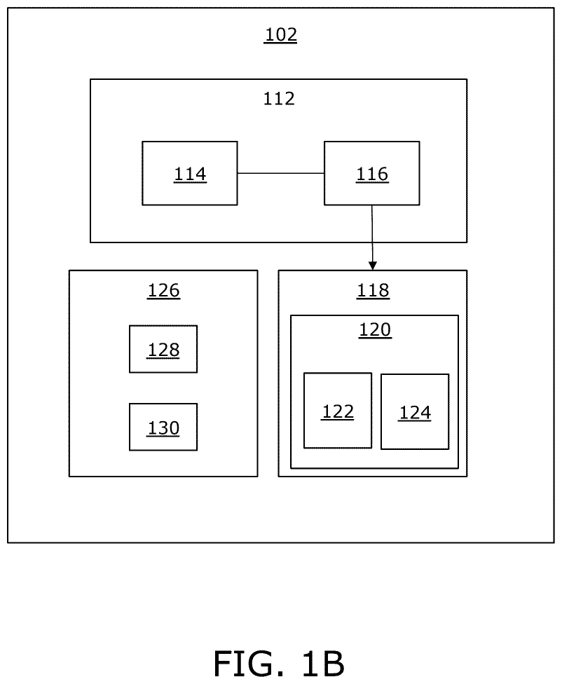

Referring to FIG. 1A, illustrated is a block diagram of a system 100 for fulfilling a service request 114 using computing nodes, while referring to FIG. 1B illustrated is a block diagram of a software framework 102 implemented by a decentralized computing network 104 of the system 100, in accordance with an embodiment of the present disclosure. Herein, the system 100 comprises the decentralized computing network 104 configured to implement a software framework 102, wherein the decentralized computing network 104 comprises a plurality of computing nodes (depicted as a first computing node 106A and a second computing node 106B) configured to operate as autonomous agents (depicted as a first autonomous agent 108A and a second autonomous agent 108B) which are configured to execute a plurality of modular and extensible software modules (depicted as a first modular and extensible software module 110A and a second modular and extensible software module 110B), wherein the autonomous agents 108A-B are communicably coupled with each other. The software framework 102 comprises a software application 112 executed on a client-agent device (for example, in an implementation the first autonomous agent 108A is the client-agent device) configured to receive the service request 114 and generate an objective 116 associated with the service request 114, and to send the objective 116 to an agent-device (AA) 118, wherein the agent-device 118 comprises a context-builder software module 120 configured to upon receiving the objective 116, send one or more queries to a machine learning model agent (ML-Model AA) and/or to access the vector database to obtain a plurality of tasks (depicted as a task 122) associated with the objective 116, and obtain a list of a plurality of autonomous agents (depicted as an autonomous agent 124) that are associated with the objective 116. Moreover, the software framework 102 comprises a processing arrangement 126 configured to generate a directed acyclic graph (DAG) 128, wherein each node in the DAG 128 represents a first task amongst the plurality of tasks and each edge in the DAG represents a dependency of the first task on second task amongst the plurality of tasks. The software framework 102 comprises a processing arrangement 126 configured to initialize a Bloom filter 130 associated with each node of the DAG 128 to track a completion status of each of at least one second task on which the first task is dependent.

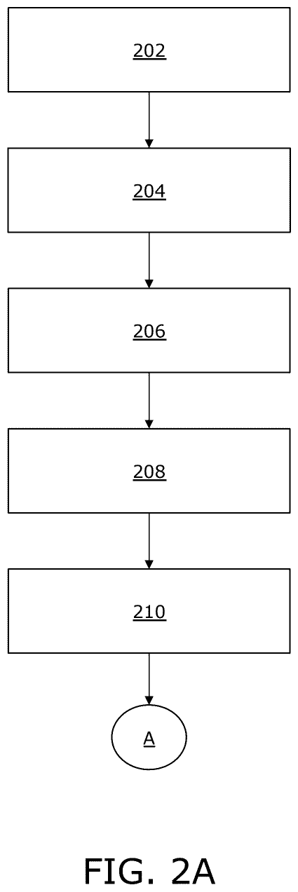

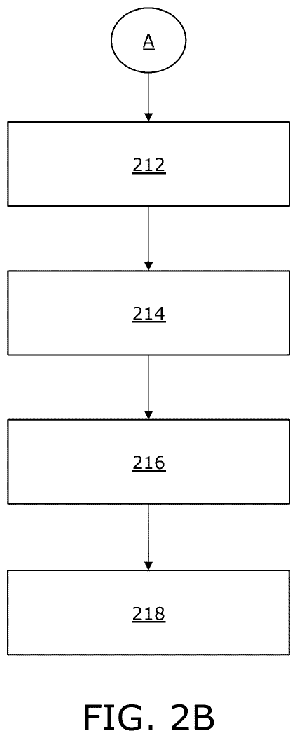

Referring to FIG. 2 (i.e. 2A and 2B), illustrated is a flowchart depicting steps of a method for fulfilling a service request using computing nodes, in accordance with an embodiment of the present disclosure. At step 202, a software framework is implemented, via a decentralized computing network, wherein the decentralized computing network comprises a plurality of computing nodes configured to operate as autonomous agents (AAs), which are configured to execute a plurality of modular and extensible software modules, wherein the autonomous agents are communicably coupled with each other. At step 204, at a client-agent device (client-AA) comprising a software application, the service request is received and an objective associated with the service request is generated, wherein the objective is in a form of one or more vectors recorded in a vector database. At step 206, the objective is sent from the client-AA to an agent-device (AA), wherein the agent-device AA comprises a context-builder software module configured to upon receiving the objective, send one or more queries to a machine learning model agent (ML-Model AA) and/or to access the vector database to obtain a plurality of tasks associated with the objective, and obtain a list of a plurality of autonomous agents that are associated with the objective. At step 208, a directed acyclic graph (DAG) is generated, wherein each node in the DAG represents a first task amongst the plurality of tasks and each edge in the DAG represents a dependency of the first task on second task amongst the plurality of tasks. At step 210, a Bloom filter associated with each node of the DAG is initialized to track a completion status of each of at least one second task on which the first task is dependent, using the processing arrangement. At step 212, the at least one second task on which the first task associated to said autonomous agent is dependent, is identified, based on the DAG. At step 214, the completion status of each of the identified at least one second task, is checked, using the Bloom filter associated with the first task. At step 216, upon successful completion of each of the identified at least one second task, the first task is executed. At step 218, the Bloom filter associated with the first task is updated.

The aforementioned steps are only illustrative and other alternatives can also be provided where one or more steps are added, one or more steps are removed, or one or more steps are provided in a different sequence without departing from the scope of the claims herein. Modifications to embodiments of the present disclosure described in the foregoing are possible without departing from the scope of the present disclosure as defined by the accompanying claims. Expressions such as “including”, “comprising”, “incorporating”, “have”, “is” used to describe and claim the present disclosure are intended to be construed in a non-exclusive manner, namely allowing for items, components or elements not explicitly described also to be present. A reference to the singular is also to be construed to relate to the plural.

1. A system (100) for fulfilling a service request (114) using computing nodes, the system comprising a decentralized computing network (104) configured to implement a software framework (102), wherein the decentralized computing network comprises a plurality of computing nodes (106A-B) configured to operate as autonomous agents (AAs) (108A-B), which are configured to execute a plurality of modular and extensible software modules (110A-B), wherein the autonomous agents are communicably coupled with each other, wherein the software framework comprises:
a client-agent device (client-AA) (112) comprising a software application configured to:
receive the service request and generate an objective (116) associated with the service request, wherein the objective is in a form of one or more vectors recorded in a vector database, and
send the objective to an agent-device (AA) (118), wherein the agent-device comprises a context-builder software module (120) configured to upon receiving the objective, send one or more queries to a machine learning model agent (ML-Model AA) and/or to access the vector database to obtain a plurality of tasks (122) associated with the objective, and obtain a list of a plurality of autonomous agents (124) that are associated with the objective;
a processing arrangement (126) configured to:
generate a directed acyclic graph (DAG) (128), wherein each node in the DAG represents a first task amongst the plurality of tasks and each edge in the DAG represents a dependency of the first task on a second task amongst the plurality of tasks, and
initialize a Bloom filter (130) associated with each node of the DAG to track a completion status of each of at least one second task on which the first task is dependent;
wherein each autonomous agent amongst the plurality of autonomous agents is configured to:
identify the at least one second task on which the first task associated to said autonomous agent is dependent, based on the DAG,
check the completion status of each of the identified at least one second task, using the Bloom filter associated with the given task,
upon successful completion of each of the identified at least one second task, execute the first task, and
update the Bloom filter associated with the first task.

2. The system (100) of claim 1, wherein the dependency of the first task amongst the plurality of tasks (122) on the at least one second task amongst the plurality of tasks is determined based on a pre-requisite workflow to be followed to execute the objective (116).

3. The system (100) of claim 1, wherein the Bloom filter (130) comprises a bit array of a predefined size.

4. The system (100) of claim 3, wherein the completion status in the Bloom filter (130) is represented using the bit array and hash functions.

5. The system (100) of claim 4, wherein a number of the hash functions and the predefined size of the bit array in the Bloom filter (130) are used to minimize false positives in the Bloom filter.

6. A method for fulfilling a service request (114) using computing nodes, the method comprising:
implementing a software framework (102), via a decentralized computing network (104), wherein the decentralized computing network comprises a plurality of computing nodes (106A-B) configured to operate as autonomous agents (AAs) (108A-B), which are configured to execute a plurality of modular and extensible software modules (110A-B), wherein the autonomous agents are communicably coupled with each other;
receiving, at a client-agent device (client-AA) (112) comprising a software application, the service request and generating an objective (116) associated with the service request, wherein the objective is in a form of one or more vectors recorded in a vector database;
sending the objective from the client-AA to an agent-device (AA) (118), wherein the agent-device comprises a context-builder software module (120) configured to upon receiving the objective, send one or more queries to a machine learning model agent (ML-Model AA) and/or to access the vector database to obtain a plurality of tasks (122) associated with the objective, and obtain a list of a plurality of autonomous agents (124) that are associated with the objective;
generating a directed acyclic graph (DAG) (128), wherein each node in the DAG represents a first task amongst the plurality of tasks and each edge in the DAG represents a dependency of the first task on a second task amongst the plurality of tasks, using a processing arrangement (126);
initializing a Bloom filter (130) associated with each node of the DAG to track a completion status of each of at least one second task on which the first task is dependent, using the processing arrangement;
identifying the at least one second task on which the first task associated to said autonomous agent is dependent, based on the DAG;
checking the completion status of each of the identified at least one second task, using the Bloom filter associated with the first task;
upon successful completion of each of the identified at least one second task, executing the first task; and
updating the Bloom filter associated with the first task.

7. The method of claim 6, wherein the dependency of the first task amongst the plurality of tasks (122) on the at least one task amongst the plurality of tasks is determined based on a pre-requisite workflow to be followed to execute the objective (116).

8. The method of claim 6, wherein the Bloom filter (130) comprises a bit array of a predefined size.

9. The method of claim 8, wherein the completion status in the Bloom filter (130) is represented using the bit array and hash functions.

10. The method of claim 9, wherein a number of the hash functions and the predefined size of the bit array in the Bloom filter (130) are used to minimize false positives in the Bloom filter.
